(19) United States
(12) Patent Application Publication
(10) Pub. No.: US 2011/0305896 A1
(43) Pub. Date: Dec. 15, 2011

(54) Multi-Layer Sheet Structure Including An Acrylic Outer Layer

(76) Inventor: Stephen Kenneth Campbell, Warsaw, IN (US)

(21) Appl. No.: 12/814,858

(22) Filed: Jun. 14, 2010

(51) Int. Cl. B32B 5/16; B29C 47/06

(52) U.S. Cl. 428/324; 156/244.11; 428/331; 428/325

(57) ABSTRACT

A multi-layer sheet structure, in an exemplary embodiment, includes a first layer of a thermoplastic olefin (TPO) composition that includes polypropylene and a filler, and a second layer that includes a polyolefin composition. The second layer positioned over at least a portion of the first layer. The multi-layer sheet structure also includes a third layer that includes an adhesive, and a fourth layer that includes a transparent acrylic composition. The third layer is between the second layer and the fourth layer.

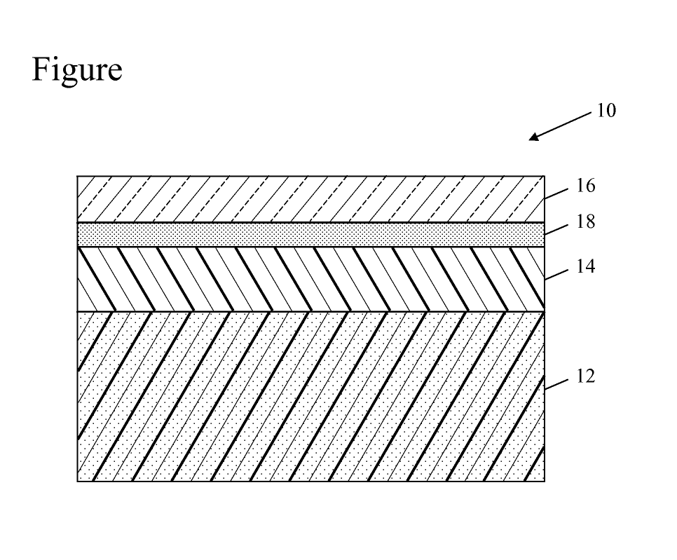

### BACKGROUND OF THE INVENTION

The field of the invention relates generally to thermoplastic olefin (TPO, also sometimes referred to herein as thermoplastic polyolefin) sheet structures and more particularly, to multi-layer TPO sheet structures that include an acrylic outer layer.

TPO extruded sheet products are used in numerous applications, for example, RV end caps and trim, marine parts, truck bed liners, parts used on recreation and leisure products (for example, ATVs, snowmobiles, and personal watercraft), and parts for automotive products. Typical TPO materials used in such applications are based on polypropylene, elastomers, and inorganic fillers. Such materials are selected based on characteristics such as weather resistance, heat resistance, impact strength, and cold temperature performance.

One known type of TPO sheet structure includes a TPO substrate layer and a high gloss polypropylene cap layer. A co-extrusion process may be utilized so that the cap layer is formed simultaneously with the TPO substrate layer. The cap layer provides a high gloss and smooth finish, which are desirable in at least some applications. The surface hardness of the polypropylene cap layer, however, is lower than the surface hardness of other known polymer compounds. The surface hardness, scratch resistance, mar resistance, and durability of the polypropylene layer may not be adequate for some applications.

In addition, with the above described sheet, the extent of sheet sag can be a constraint in thermoforming operations. More particularly, in thermoforming operations, the sheet is heated to its softening point and then drawn over or into a mold. Vacuum and air pressure may be used to facilitate forming the heated, pliable sheet into the desired part shape. As the sheet cools on the mold, the sheet solidifies into the size and shape needed for the end-use application.

With respect to sag, the sheet including the polypropylene cap layer has a low melt strength characteristic, at least relative to other polymer types such as ABS and PVC-based compounds. Such a low melt strength characteristic may result in undesirable sagging of the sheet during the thermoforming process. Specifically, as the sheet is heated and softened in an oven, the sheet may sag due to gravity and other forces operating on the sheet. This sag is accentuated with thick, heavy sheet and large sheet sizes, for example, in excess of 8-feet square. Such large heavy sheets, however, are very useful with respect to many desired end-uses.

Such sag can cause difficulties in connection with the forming process. For example, in the event of excessive sag, the sheet can tear. Also, such sag can limit the temperature operating ranges of the thermoforming oven to less than desired temperatures, cause surface flaws in the final part, such as folds and webs, and limit the final part design to shapes that are easier to thermoform.

In an attempt to address at least some of the shortcomings with the above described two layer structure described above, three layer structures can be utilized. A typical three layer structure includes a TPO substrate layer, an adhesive layer, and a colored acrylic layer. The colored acrylic layer may, however, have reduced gloss (in comparison to the polypropylene cap layer) and have surface flaws, such as agglomerates, gels and streaks. Also, the sheet surface may be distorted because the colored acrylic layer is laminated over the rougher TPO substrate layer. The adhesive layer positioned between the TPO substrate layer and the colored acrylic layer does not mitigate the roughness effect because the adhesive layer is typically very thin.

Rather than using a colored acrylic layer in the three layer structure described above, a clear acrylic layer can be utilized. Many highly chromatic color shades may not be possible to attain in the TPO substrate layer, however, due to the amount of filler in the TPO substrate layer. The filler present in the TPO substrate layer may wash out the color appearance of brilliant highly chromatic colors as well as metallic, pearlescent, or other special effect pigment systems.

### BRIEF DESCRIPTION OF THE INVENTION

In one aspect, a four-layer sheet structure is described. The four-layer sheet structure includes a first layer of a TPO composition that includes polypropylene and a filler, and a second layer that includes a polyolefin composition. The second layer is positioned over at least a portion of the first layer. The four-layer sheet structure also includes a third layer that has an adhesive, and a fourth layer that includes a transparent acrylic composition. The third layer is between the second layer and the fourth layer.

In another aspect, a method of making a four-layer sheet structure is provided. The method includes co-extruding a TPO composition and a polypropylene composition to form a layered structure having a TPO layer and a polypropylene layer. The TPO composition includes a polypropylene and a filler. The method further includes providing a transparent acrylic film, applying an adhesive onto at least one of a surface of the polypropylene layer and a surface of the transparent acrylic film, and applying the acrylic film to the polypropylene layer with the adhesive between the acrylic film and the polypropylene layer.

### BRIEF DESCRIPTION OF THE DRAWINGS

The FIGURE is a sectional schematic illustration of a multi-layer sheet structure in accordance with an exemplary embodiment.

### DETAILED DESCRIPTION OF THE INVENTION

A multi-layer TPO sheet having a transparent acrylic outer layer is described below in detail. The multi-layer TPO sheet, in an exemplary embodiment, includes four layers. Specifically, the sheet includes a substrate layer of TPO, a polypropylene cap layer, a transparent acrylic layer and an adhesive layer between the polypropylene cap layer and the adhesive layer. Although the sheet is specifically described herein as having four layers, it is contemplated that additional layers could be utilized in connection with such sheet, depending on the desired characteristics and application. The term “TPO” as used herein means thermoplastic olefin (i.e., thermoplastic polyolefin) and filler compositions. The thermoplastic olefin and filler composition may also include an elastomer material.

The combination of the substrate layer, the polypropylene cap layer and the outer acrylic layer provide increased melt strength as compared to known multi-layer TPO sheets that only include a substrate layer and a polypropylene cap layer or an acrylic cap layer. In addition, the four-layer sheet facilitates providing an improved surface appearance and improved surface physical properties as compared to at least some known TPO structures. Specifically, the four-layer TPO sheet has a smooth outer layer and a more brilliant depth of image appearance with a “clear-coat paint look”, as compared to at least some known TPO sheets having two or three layers. Also, the four-layer TPO sheet can be colored with highly chromatic color shades and has a brilliant color appearance. Further, the four-layer TPO sheet has a surface hardness, scratch and mar resistance, and durability that facilitate using such sheet in a wide variety of applications.

The FIGURE is a sectional schematic illustration of a multi-layer sheet structure 10 in accordance with an example embodiment. Multi-layer sheet structure 10 includes a substrate layer 12 formed of a polypropylene based TPO composition, a cap layer 14 formed of a polypropylene composition, a transparent acrylic layer 16, and an adhesive layer 18 between cap layer 14 and acrylic layer 16.

The TPO composition is a filled polypropylene compound that may include other components. The TPO composition may include a polypropylene base composition, fillers, and optional materials, for example, an elastomer composition, and other additives.

The polypropylene base composition includes one or more of a polypropylene homopolymer, a random polypropylene co-polymer formed with alpha-olefins such as ethylene, butene, hexene, and the like, and an impact polypropylene co-polymer with a discrete rubber phase based on ethylene or propylene co-polymer elastomers. Polypropylene polymers with branched chain structures may also be used. The amount of the polypropylene base composition in the TPO composition, in one embodiment, is in the range of about 30% to about 95% by weight, in another embodiment about 54% to about 90%, and in another embodiment about 50% to about 80% by weight, based on the total weight the TPO composition.

The TPO composition includes one or more fillers. Suitable fillers include, but are not limited to, talc, calcium carbonate, mica, fibrous material such as fiberglass and natural fibers, as well as mineral fillers, for example, wollastonite, silicate, carbon black and/or clays. Reinforcing fillers of the plate or fiber types that exhibit significant aspect ratios may be used. Aspect ratios of the reinforcing filler are significantly larger in size in one dimension (fibrous-type) or two (plate-type) dimensions than the remaining dimension(s). Plate-like fillers such as mica, talc, and the nano-fillers, which are very small particle size exfoliated clay compositions, may be used. Filler particle sizes, in one embodiment, may range from about 0.3 microns to about 25 microns average particle size, and in another embodiment, from about 1.0 microns to about 20 microns. Fibrous-type fillers may range from about 3 microns to about 50 microns in diameter, and about 0.06 inch to 0.5 inch in length. Also, long fiber fillers may be used. In one embodiment, the long fiber fillers are of about 0.5 inch to 4 inches in length, and in another embodiment from about 0.5 inch to about 2 inches. Plate-like fillers may have a wide range of aspect ratios, for example, from greater than about 1:1 to about 1:100, and in another embodiment from about 1:1 to about 1:150. Nano-fillers, for example fully exfoliated clay materials, may have particle sizes in the range of, in one embodiment, about 1 nm to about 200 nm average diameter, and in another embodiment, about 1 nm to about 100 nm average diameter.

The amount of filler in the TPO composition, in one embodiment, is in the range of about 1% to about 60% by weight, in another embodiment, about 5% to about 50% by weight, and in another embodiment, about 15% to about 40% by weight, based on the weight of the TPO composition. Coated or treated fillers can also be used for the filler component of the TPO composition. Example treatments that may be used include, but are not limited to, metal stearates, silane, titanate coupling agents, and other materials that improve bonding between the filler surface and the polymeric matrix components.

An elastomer material may be added to the TPO composition to improve properties such as impact resistance, cold temperature ductility and melt strength during part shaping operations, for example, thermoforming. The elastomer materials used are partially compatible with the polypropylene base composition described above. The elastomer materials are generally composed of polyethylene co-polymers with propylene, butene, hexene, octene, ethylidene norbornene and/or other alpha-olefin co-monomers. In similar fashion, elastomeric co-polymers based on polypropylene may be used. When used, the elastomer content in the TPO composition, in one embodiment, is in the range of about 1% to about 40% by weight, in another embodiment, about 3% to about 30% by weight, and in another embodiment, about 5% to about 25% by weight, based on the weight of the TPO composition. The elastomer material is in addition to any rubbery component contained in the polypropylene base composition if an impact co-polymer is used in the polypropylene base composition.

A variety of additives may be used to improve the processing and performance of the TPO composition. Suitable additives may include, but are not limited to, anti-oxidants, process aids, pigments, dyes, light stabilizers, heat stabilizers, lubricants, and the like. The amount of each additive is chosen to give the desired performance effects as needed for the end-use application. Additive materials can be incorporated into the TPO composition during melt mixing or may be added in masterbatch form during sheet extrusion.

The TPO composition can be prepared by melt compounding the components with equipment known in the art. The equipment may include continuous and batch mixers, for example, Farrel Continuous Mixers available from Farrel Corporation, Ansonia, Conn., Banbury® mixers available from Farrel Corporation, single screw extruders, multiple screw extruders, and the like. Also, compounding and melt mixing of the TPO components in a continuous fashion in-line with the production of extruded multi-layer sheet structure 10 may also be used.

Cap layer 14 is formed of a polypropylene composition that includes the polypropylene base composition described above. The polypropylene base composition used to form cap layer 14 can be the same or different from the polypropylene base composition used to form TPO substrate layer 12, and could be a polypropylene homopolymer, random co-polymer and/or impact co-polymer types. Especially useful are random co-polymers containing clarifying agents that control the crystallite domain to a very small size. The clarified nature of the polypropylene base composition used in cap layer 14 facilitates the functionality and appearance properties of multi-layer sheet structure 10.

In general, particulate filler materials are not used in cap layer 14. However, a low level of conventional fillers (described above), for example, about 0% to about 5% by weight may be used, as long as their presence does not significantly detract from the clarity of the polypropylene composition used in cap layer 14. Also, nano-type fillers may be used. The small size of nano-type fillers facilitates maintaining the functional clarity of the polypropylene composition used in cap layer 14.

In addition, an elastomer material, described above, may also be included in the polypropylene composition used in cap layer 14.

Additives can be used in cap layer 14. If multi-layer sheet structure 10 and any functional parts derived from the sheet structure are intended for outdoor exposure, a light stabilizer additive system may be used. The classes of light stabilizers that are useful include, but are not limited to, light absorbers, metal quenchers/deactivators and hindered amine light stabilizers. Coloring additives may also be used. Suitable coloring additives include, but are not limited to, organic and inorganic pigments, dyes, metallic and other special effects pigments, and/or optical brightener components. Some pigments and colorants also have known absorptive properties that assist in light stability, especially in an outdoor exposure end-use. Additive materials can be incorporated into the polypropylene base composition used in cap layer 14 during melt mixing or may be added in masterbatch form during sheet extrusion.

The polypropylene composition can be prepared by melt compounding the components with equipment known in the art. The equipment may include continuous and batch mixers, for example, Farrel Continuous Mixers, Banbury® mixers, single screw extruders, multiple screw extruders, and the like. Also, compounding and melt mixing of the polypropylene composition in a continuous fashion in-line with the production of extruded multi-layer sheet structure 10 may also be used.

Acrylic layer 16 is formed from an acrylic composition that includes an acrylic polymer or blends of acrylic polymers. Suitable thermoplastic acrylic polymers are formed, in one embodiment, by polymerizing an alkyl (meth)acrylate monomer. The thermoplastic acrylic polymers can be copolymers of one or more alkyl esters of acrylic acid or methacrylic acid having from 1 to 20 carbon atoms in the alkyl group optionally together with one or more other polymerizable ethylenically unsaturated monomers. Suitable alkyl esters of acrylic acid or methacrylic acid include methyl (meth)acrylate, isobutyl (meth)acrylate, ethyl (meth)acrylate, n-butyl (meth)acrylate, and 2-ethylhexyl (meth)acrylate. Suitable other copolymerizable ethylenically unsaturated monomers include vinyl aromatic compounds such as styrene, vinyl toluene, and alpha-methyl styrene dimer; nitriles such as acrylonitrile and methacrylonitrile; vinyl and vinylidene halides such as vinyl chloride and vinylidene fluoride and vinyl esters such as vinyl acetate. It should be understood that the term “(meth)acrylate” refers to both methacrylate and acrylate. In addition, reactive monomers of the above described monomers having more than one reactive site can also be used in combination with non-reactive monomers.

The acrylic polymer can be modified with various monomers as well as with rubber components, as long as the clarity of the acrylic composition is maintained. Rubber components can include n-butyl acrylate and co-polymers. Rigid phase co-monomers that can be used include methyl acrylate, ethyl acrylate, ethyl methacrylate, propyl acrylate, and the like. Additives such as anti-oxidants, process aids, and, UV/light stabilizers may be added. Optionally, dyes and very small particle size pigments that color acrylic layer 16 while maintaining its transparency may be used. Particulate pigments that would opacify acrylic layer 16 are not used.

The acrylic composition can be in the form of pelletized feed material if a co-extrusion method is used to apply acrylic layer 16 to multi-layer sheet structure 10. Also, acrylic layer 16 can be pre-fabricated into a thin film suitable for lamination to cap layer 14, either in-line during sheet extrusion or during a subsequent secondary lamination step. The acrylic thin film can be produced by various known methods, for example, blown film, cast film, and other known web-based processes.

Adhesive layer 18 includes any adhesive material that would successfully bond acrylic layer 16 to polypropylene cap layer 14. The adhesive material maintains the bond between acrylic layer 16 and polypropylene cap layer 14 during the service life of the multi-layer sheet structure and/or a finished part. If the end-use is in outdoor environments, the adhesive should be stable to the temperature and UV/light exposure through transparent acrylic layer 14. The acrylic composition of acrylic layer 16 can be designed to absorb a significant fraction of the most damaging UV radiation using UV/light stabilizer additives. Adhesive layer 18 is transparent to permit the surface color and visual attributes of polypropylene cap layer 14 to show through. In addition, the adhesive composition is resilient to draw with the rest of the sheet structure during thermoforming fabrication, without tearing or otherwise causing separation between acrylic layer 16 and polypropylene cap layer 14 during the heating, stretching, and cooling of thermoforming. An example of a suitable adhesive material is OSM TPO Sealer (Product Code EXP-049) commercially available from Hi-Tech Color, Inc., Odenton, Md.

Multi-layer sheet structure 10 may be fabricated by co-extruding substrate layer 12 and polypropylene cap layer 14, and separately extruding acrylic layer 16. Adhesive layer 18 is applied to acrylic layer 16 or cap layer 14, and acrylic layer 16 is applied to cap layer 14. Adhesive layer 18 may be applied by spraying the adhesive composition onto a surface of acrylic layer 16 and/or a surface of cap layer 14. Alternatively, adhesion layer may be roll coated onto a surface of acrylic layer 16 or cap layer 14 with, for example, a gravure roll.

In another embodiment, multi-layer sheet structure 10 is fabricated by co-extruding substrate layer 12, polypropylene cap layer 14, adhesive layer 18, and acrylic layer 16 together. In another embodiment, multi-layer sheet structure 10 is fabricated by co-extruding substrate layer 12, polypropylene cap layer 14, and adhesive layer 18 together. Acrylic layer 16 is extruded separately to form a film which is then laminated to cap layer 14 with adhesive layer between cap layer 14 and acrylic layer 16.

The following examples are presented for the purpose of illustration only and are not intended to limit the scope of the claims.

### Example I

A test sheet of a multi-layer sheet structure 10 was compared to a control sheet. The test sheet was formed by co-extruding a TPO composition, Extreme™ TPO Compound, commercially available from Spartech Corporation, St. Louis, Mo., and a polypropylene composition, Dow 6D83K, commercially available from Dow Chemical Company, and then laminating a clear acrylic film, Korad® 5001 sheet, commercially available from Spartech Corporation, onto the top surface of the polypropylene layer with an adhesive material, EXP-049, commercially available from Hi-Tech Color, Inc., Odenton, Md., between the polypropylene layer and the acrylic film. Five percent by weight of a blue color masterbatch was added to the Extreme™ TPO Compound. Five percent by weight of the blue masterbatch, and three percent of a UV stabilizer masterbatch that contained a UV absorber and a hindered amine light stabilizer was added to the Dow 6D83K polypropylene composition. The thickness of the co-extruded sheet was about 0.275 inch with 90% of the thickness being the TPO substrate layer and 10% of the thickness being the polypropylene layer. The thickness of the acrylic film was about 0.003 inch. The test sheet product was blue in color.

A control sheet material was prepared similar to the test sheet described above. In this case the control sheet was the polypropylene composition and TPO composition co-extruded structure in the same color and thickness as the test sheet, but without the acrylic film or adhesive.

A thermoforming test was designed to gather data on the relative melt strengths of TPO sheet compositions and structures. An outline of the thermoforming procedure includes:
(1) On a shuttle-type thermoformer, set oven heat settings at: Top Heaters—40% and Bottom Heaters—60%.
(2) Cut test sheet to the size of 35 inches by 43 inches.
(3) Place test sheet in thermoformer clamp frames with the cap layer (top) side down.
(4) Move clamp frame into oven with the sheet in place.
(5) Heat test sheet in oven until 9 inches of sag is measured by a laser leveler preset to this depth.
(6) Move clamp frame with sheet out of the oven.
(7) Measure and record top (sheet backing) and bottom (cap layer) plastic temperature using a non-contact IR instrument.
(8) Let the test sheet continue to sag under its own weight as the plastic material cools to room temperature.
(9) When test sheet material is cooled to room temperature, remove sagged test sheet from clamp frames.
(10) Measure the depth of sag in the shape after cooling.

Table I shows a comparison of the test results for the test sheet with the acrylic film and the control test sheet. Two ratios were calculated: (1) sag depth ratio (depth of sag after cooling/initial test sheet thickness) and (2) heating time ratio (time to reach 9 inches sag/test sheet thickness in mils).

TABLE I

| | | | | | | | Heating |
|---|---|---|---|---|---|---|---|
| | Sheet | | | | | Sag | Time |
| | Thick- | Sag | Sag | Cap | Back | Depth | Ratio |
| Sheet | ness | Time | Depth | Temp. | Temp. | Ratio | (sec/ |
| Material | (inch) | (sec) | (inch) | (° F.) | (° F.) | (in/in) | mil) |
| Test | 0.279 | 211 | 15.0 | 371 | 390 | 53.8 | 0.76 |
| Sheet | | | | | | | |
| Control | 0.276 | 195 | 17.5 | 361 | 391 | 63.4 | 0.71 |
| Sheet | | | | | | | |

The data in Table I shows that the test sheet with the acrylic film lamination has a longer time to reach the 9-inch oven sag level, and a much lower sag distance after cooling compared to the control sheet. Measured sheet temperatures were very similar for the test sheet and control sheet. These results are also reflected in the two calculated ratio values.

### Example II

A test sheet was formed similar to Example I except that a white color masterbatch was substituted for the blue color masterbatch added to the TPO composition and polypropylene composition of Example I. Specifically, the test sheet was formed by co-extruding a TPO composition, Extreme™ TPO Compound, and a polypropylene composition, Dow 6D83K, and then laminating a clear acrylic film, Korad® 5001 sheet, onto the top surface of the polypropylene layer with an adhesive material, EXP-049, between the polypropylene layer and the acrylic film. Five percent by weight of a white color masterbatch was added to the Extreme™ TPO Compound. Five percent by weight of the white masterbatch, and three percent of a UV stabilizer masterbatch that contained a UV absorber and a hindered amine light stabilizer were added to the Dow 6D83K polypropylene composition. The overall sheet thickness was 0.187 inch.

A control sheet material was prepared similar to the test sheet described above. In this case the control sheet included an extruded TPO layer of the Extreme™ TPO Compound that included the white color masterbatch, an adhesive layer, EXP-049, and an acrylic film that included a white pigment, Korad® 65000 sheet. The control is a three-layer structure having a non-transparent acrylic layer that was compared to the four layer test sheet.

Gloss measurements, 60° Garner Gloss, were taken on the test sheet and control sheet per ASTM D523. The test sheet had a 60° Gardner Gloss of 85.4%, and the three layer control sheet had a 60° Gardner Gloss of 61.3%.

### Example III

A test sheet was prepared similar to the test sheet in Example II except that the white color master batch was replaced with 4% of red color masterbatch. Specifically, the test sheet was formed by co-extruding a TPO composition, Extreme™ TPO Compound, and a polypropylene composition, Dow 6D83K, and then laminating a clear acrylic film, Korad® 5001 sheet, onto the top surface of the polypropylene layer with an adhesive material, EXP-049, between the polypropylene layer and the acrylic film. Four percent by weight of a red color masterbatch was added to the Extreme™ TPO Compound. Four percent by weight of the red masterbatch, and three percent of a UV stabilizer masterbatch that contained a UV absorber and a hindered amine light stabilizer were added to the Dow 6D83K polypropylene composition.

A control sheet material was prepared similar to the test sheet described above. The control sheet included the extruded TPO composition layer of the Extreme™ TPO Compound, the adhesive layer of EXP-049 and a pigmented Korad® sheet color matched to the red color of the test sheet. The control sheet is a three-layer structure using a pigmented acrylic layer that was compared to the four layer test sheet.

Gloss measurements, 60° Garner Gloss, were taken on the test sheet and control sheet per ASTM D523. The test sheet had a 60° Gardner Gloss of 84.5%, and the three layer control sheet had a 60° Gardner Gloss of 75.6%.

Multi-layer sheet structures 10, having four layers, described above have numerous advantages to known multi-layer sheet structures. The combination of TPO substrate layer 12, polypropylene cap layer 14, adhesive layer 18, and outer acrylic layer 16 provide increased melt strength of the multi-layer TPO sheet as compared to known multi layer TPO sheets that only include a substrate layer and a polypropylene cap layer or an acrylic cap layer.

Also, four-layer sheet structure 10 having an outer clear acrylic layer 16 compared to a known three-layer structure having a TPO substrate layer, an adhesive layer, and a colored acrylic layer has a number of appearance advantages. For example, acrylic layer 16 may facilitate a brilliant depth of image appearance of four-layer sheet structure 10. Pigment in the colored acrylic layer of the known three-layer structure may reduce gloss and may increase chances of surface flaws, such as agglomerates, gels and streaks. Because polypropylene cap layer 14 has a smooth surface, laying acrylic layer 16 over the smooth surface of cap layer 14 may facilitate a better sheet surface than laminating the colored acrylic layer over the rougher TPO substrate layer of the known three-layer structure. The adhesive layer does not mitigate this effect because of the adhesive layer may be made very thin, usually about 100 μm to about 500 μm.

In addition, four-layer sheet structure 10 having an outer clear acrylic layer 16 compared to a known three-layer structure having a TPO substrate layer, an adhesive layer, and a clear acrylic layer has a number of appearance advantages. For example, many highly chromatic color shades are not possible to attain in the TPO substrate layer due to the filler loading in the composition. These shades cannot be obtained in the comparison sheet structure, but are easily produced in the unfilled polypropylene cap layer 14 of multi-layer sheet structure 10. The high gloss polypropylene cap layer 14 may facilitate a brilliant color appearance. The filler present in the TPO substrate layer washes out the color appearance of brilliant highly chromatic colors as well as metallic, pearlescent, or other special effect pigment systems.

Four-layer sheet structure 10 having an outer clear acrylic layer 16 compared to a known multi-layer structure having a TPO substrate layer and a high gloss polypropylene layer also has a number of appearance advantages. For example, clear acrylic layer 16 has higher surface hardness, scratch and mar resistance, and durability than the high gloss polypropylene layer of at least some of the known multi-layer structures. Also, clear acrylic layer 16 fills in and covers flaws in polypropylene cap layer 14 and reduces the visibility of gels, pits, and particulates in cap layer 14. The acrylic layer 16 may facilitate a brilliant depth of image appearance of four-layer sheet structure 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A multi-layer sheet structure comprising:
a first layer comprising a thermoplastic olefin (TPO) composition comprising polypropylene and a filler;
a second layer comprising a polyolefin composition, said second layer over at least a portion of said first layer;
a third layer comprising an adhesive; and
a fourth layer comprising a transparent acrylic composition, said third layer between said second layer and said fourth layer.

2. A multi-layer sheet structure in accordance with claim 1 wherein said polypropylene comprises at least one of a propylene homopolymer, a random polypropylene co-polymer formed with alpha-olefins, and an impact polypropylene co-polymer with a discrete rubber phase based on ethylene or propylene co-polymer elastomers.

3. A multi-layer sheet structure in accordance with claim 1 wherein said filler comprises at least one of talc, calcium carbonate, mica, fibrous materials, glass fibers, natural fibers, mineral fillers, wollastonite, silicate, carbon black and clays.

4. A multi-layer sheet structure in accordance with claim 1 wherein said TPO composition further comprises an elastomer.

5. A multi-layer sheet structure in accordance with claim 4 wherein said elastomer comprises polyethylene co-polymers with propylene, butene, hexene, octene, ethylidene norbornene and alpha-olefin co-monomers.

6. A multi-layer sheet structure in accordance with claim 1 wherein said TPO composition further comprises at least one of anti-oxidants, process aids, pigments, dyes, light stabilizers, heat stabilizers, and lubricants.

7. A multi-layer sheet structure in accordance with claim 1 wherein said polyolefin composition of said second layer comprises at least one of a propylene homopolymer, a random polypropylene co-polymer formed with alpha-olefins, and an impact polypropylene co-polymer with a discrete rubber phase based on ethylene or propylene co-polymer elastomers.

8. A multi-layer sheet structure in accordance with claim 1 wherein said transparent acrylic composition comprises an alkyl (meth)acrylate polymer composition.

9. A multi-layer sheet structure in accordance with claim 8 wherein said alkyl (meth)acrylate polymer composition comprises at least one of methyl acrylate, methyl methacrylate, ethyl acrylate, ethyl methacrylate, propyl acrylate, propyl methacrylate, n-butyl acrylate, n-butyl methacrylate, and copolymers thereof.

10. A multi-layer sheet structure in accordance with claim 1 wherein said adhesive comprises a heat activated adhesive.

11. A method of making a multi-layer sheet structure, said method comprising:
co-extruding a TPO composition and a polypropylene composition to form a layered structure comprising a TPO layer and a polypropylene layer, the TPO composition comprising a polypropylene and a filler;
providing a transparent acrylic film;
applying an adhesive onto at least one of a surface of the polypropylene layer and a surface of the transparent acrylic film; and
applying the transparent acrylic film to the polypropylene layer with the adhesive between the acrylic film and the polypropylene layer.

12. A method of making a multi-layer sheet structure in accordance with claim 11 wherein the polypropylene comprises at least one of a propylene homopolymer, a random polypropylene co-polymer formed with alpha-olefins, and an impact polypropylene co-polymer with a discrete rubber phase based on ethylene or propylene co-polymer elastomers.

13. A method of making a multi-layer sheet structure in accordance with claim 11 wherein the filler comprises at least one of talc, calcium carbonate, mica, fibrous materials, glass fibers, natural fibers, mineral fillers, wollastonite, silicate, carbon black and clays.

14. A method of making a multi-layer sheet structure in accordance with claim 11 wherein the TPO composition further comprises an elastomer.

15. A method of making a multi-layer sheet structure in accordance with claim 14 wherein the elastomer comprises polyethylene co-polymers with propylene, butene, hexene, octene, ethylidene norbornene and alpha-olefin co-monomers.

16. A method of making a multi-layer sheet structure in accordance with claim 11 wherein said TPO composition further comprises at least one of anti-oxidants, process aids, pigments, dyes, light stabilizers, heat stabilizers, and lubricants.

17. A method of making a multi-layer sheet structure in accordance with claim 11 wherein the polyolefin composition comprises at least one of a propylene homopolymer, a random polypropylene co-polymer formed with alpha-olefins, and an impact polypropylene co-polymer with a discrete rubber phase based on ethylene or propylene co-polymer elastomers.

18. A method of making a multi-layer sheet structure in accordance with claim 11 wherein applying an adhesive comprises applying an adhesive by at least one of spraying the adhesive onto at least one of a surface of the polypropylene layer and a surface of the transparent acrylic film, and roll coating the adhesive onto at least one of a surface of the polypropylene layer and a surface of the transparent acrylic film.

19. A method of making a multi-layer sheet structure in accordance with claim 11 wherein applying an adhesive comprises applying an adhesive by at least one of spraying the adhesive onto a surface of the transparent acrylic film, and roll coating the adhesive onto a surface of the transparent acrylic film; and
applying the transparent acrylic film to the polypropylene layer comprises laminating the adhesive coated transparent acrylic film to the polypropylene layer with the adhesive between the transparent acrylic film and the polypropylene layer.

20. A method of making a multi-layer sheet structure in accordance with claim 11 wherein the adhesive is an extruded sheet, and applying an adhesive comprises positioning the extruded sheet of adhesive between the polypropylene layer and the transparent acrylic film.

21. A multi-layer TPO sheet structure comprising:
a propylene based TPO substrate layer comprising polypropylene and a filler;
a polypropylene cap layer bonded to said TPO substrate layer;
a transparent acrylic layer; and
an adhesive between said polypropylene cap layer and said transparent acrylic layer to bond said transparent acrylic layer to said polypropylene cap layer.

22. A multi-layer TPO sheet structure in accordance with claim 21 wherein said polypropylene comprises at least one of a propylene homopolymer, a random polypropylene co-polymer formed with alpha-olefins, and an impact polypropylene co-polymer with a discrete rubber phase based on ethylene or propylene co-polymer elastomers.

23. A multi-layer TPO sheet structure in accordance with claim 21 wherein said filler comprises at least one of talc, calcium carbonate, mica, fibrous materials, glass fibers, natural fibers, mineral fillers, wollastonite, silicate, carbon black and clays.

24. A multi-layer TPO sheet structure in accordance with claim 21 wherein said TPO substrate layer further comprises an elastomer.

25. A multi-layer sheet structure in accordance with claim 24 wherein said elastomer comprises polyethylene co-polymers with propylene, butene, hexene, octene, ethylidene norbornene and alpha-olefin co-monomers.

26. A multi-layer sheet structure in accordance with claim 21 wherein said TPO composition further comprises at least one of anti-oxidants, process aids, pigments, dyes, light stabilizers, heat stabilizers, and lubricants.

27. A multi-layer TPO sheet structure in accordance with claim 21 wherein said polypropylene cap layer comprises at least one of a propylene homopolymer, a random polypropylene co-polymer formed with alpha-olefins, and an impact polypropylene co-polymer with a discrete rubber phase based on ethylene or propylene co-polymer elastomers.

28. A multi-layer TPO sheet structure in accordance with claim 21 wherein said transparent acrylic composition comprises an alkyl (meth)acrylate polymer composition.

29. A multi-layer TPO sheet structure in accordance with claim 28 wherein said alkyl (meth)acrylate polymer composition comprises at least one of methyl acrylate, methyl methacrylate, ethyl acrylate, ethyl methacrylate, propyl acrylate, propyl methacrylate, n-butyl acrylate, n-butyl methacrylate, and copolymers thereof.

30. A multi-layer TPO sheet structure in accordance with claim 21 wherein said adhesive comprises a heat activated adhesive.

31. A method of making a multi-layer TPO sheet structure, said method comprising:
extruding a sheet of a TPO layer comprising polypropylene and a filler;
extruding a polypropylene layer onto the TPO layer;
providing a transparent acrylic film;
applying an adhesive on at least one of the polypropylene layer and the transparent acrylic film; and
applying the transparent acrylic film onto the polypropylene layer.

32. A method of making a multi-layer TPO sheet structure in accordance with claim 31 wherein the polypropylene comprises at least one of a propylene homopolymer, a random polypropylene co-polymer formed with alpha-olefins, and an impact polypropylene co-polymer with a discrete rubber phase based on ethylene or propylene co-polymer elastomers.

33. A method of making a multi-layer TPO sheet structure in accordance with claim 31 wherein applying an adhesive comprises applying an adhesive by at least one of spraying the adhesive onto a surface of the transparent acrylic film, and roll coating the adhesive onto a surface of the transparent acrylic film; and
applying the transparent acrylic film to the polypropylene layer comprises laminating the adhesive coated transparent acrylic film to the polypropylene layer with the adhesive between the transparent acrylic film and the polypropylene layer.

34. A method of making a multi-layer TPO sheet structure, said method comprising:
extruding a sheet of a TPO layer comprising polypropylene and a filler;
extruding a polypropylene layer onto the TPO layer;
extruding an adhesive layer onto the polypropylene layer; and
extruding a transparent acrylic film onto the adhesive layer.

35. A method of making a multi-layer TPO sheet structure in accordance with claim 34 wherein the polypropylene comprises at least one of a propylene homopolymer, a random polypropylene co-polymer formed with alpha-olefins, and an impact polypropylene co-polymer with a discrete rubber phase based on ethylene or propylene co-polymer elastomers.
